(19) United States
(12) Patent Application Publication
(10) Pub. No.: US 2005/0234775 A1
(43) Pub. Date: Oct. 20, 2005

(54) Self-funded commission management system

(76) Inventors: Eric Edward Pearson, Atlanta, GA (US); Michael Menis, Dunwoody, GA (US); Daniel Delano Ross JR., Norcross, GA (US)

Correspondence Address: NEEDLE & ROSENBERG, P.C., SUITE 1000, 999 PEACHTREE STREET, ATLANTA, GA, 30309-3915, US

(21) Appl. No.: 11/106,020

(22) Filed: Apr. 14, 2005

Related U.S. Application Data
(60) Provisional application No. 60/562,373, filed on Apr. 14, 2004.

(51) Int. Cl. G06F 17/60

(52) U.S. Cl. 705/14

(57) ABSTRACT

A self-funded commission management system is described. The system has a memory storage element for storing commission management software that assigns an affiliate identifier for an affiliate. A user-initiated transaction is received, which is associated with the affiliate identifier. A confirmation that the user-initiated transaction produced a consumed transaction associated with the affiliate identifier is received. A commission associated with the consumed transaction is also received from the entity which ultimately delivered the final product or service to the user and derived the economic value from the user-initiated transaction. The commission is deposited by the advertiser or primary beneficiary of the advertisement into a central fund from which disbursements of all payments are made. The memory element generates a payment signal in response to determining the payment for the affiliate. A microprocessor operatively coupled to receive the payment signal from the memory element. The microprocessor transmits a payment to the affiliate in response to receiving the payment signal.

### CROSS REFERENCE TO RELATED APPLICATIONS

This application claims priority to a U.S. Provisional Patent Application with application No. 60/562,373 entitled “CENTRALIZED PAYMENT SYSTEM AND METHOD FOR SELF-FUNDED ADVERTISING, which was filed on Apr. 14, 2004. This application is hereby incorporated by reference in its entirety.

### BACKGROUND

With the evolution of technology, companies have various methods, such as advertising, for increasing their customer base. Advertising techniques have evolved with the advent of new technology including technologies which enable advertising deal structures which are based upon commissions paid by the advertiser or the primary beneficiary of the advertisements based upon the results of the advertisements. Conventional advertising programs, including those based upon commission management schemes, mandate that companies designate at the beginning of each fiscal year resources that will cover the cost of both on-line advertising and traditional advertising. Creating an advertising budget is a considerable cost to a company both in time and resources and requires a sophisticated approach to forecasting in order to ensure efficient budgeting and optimal use of resources. As advertising vendors submit invoices for payment during the year, companies can pay these invoices from the appropriate advertising budget. Thus, the maximum that a company can spend is the original budgeted amount, which does not consider the effectiveness of the advertising campaign. Because companies can not spend more than the budgeted amount, they may be unable to compete in the market place with companies that allocate large amounts on advertising. The evolution of the Internet as a business medium has enabled marketers to measure the results of their efforts to an unparalleled degree. These results can be compared with the costs of these efforts and further compared to the economics of the underlying business to determine whether or not such efforts are, in fact, worthwhile. If the costs of marketing efforts were tied to the value derived from these efforts in a way that enabled these efforts to be self-funded to a large extent, this would be of tremendous value to marketers—but only if they were able to attribute the derived value to the marketing campaign. By determining the derived value, companies could appropriate share of this value (in some form of a commission or bounty) in a timely and efficient way that would enable the marketing campaign to be sustained indefinitely or at least until it ceases to deliver the appropriate level of value. Hence, there remain unmet needs in paying commissions associated with advertising.

### SUMMARY

Embodiments of the invention include a self-funded commission tracking, collection, and payment disbursement/invoice reconciliation system. In a preferred embodiment, the system has a memory storage element in the form of software that stores tracking information including amounts due for commissions, origination source of the commissionable event, and payment obligations to that origination source. An “affiliate” is “an external entity which serves to present the services or product of a marketer for the purpose of promoting the desired end-user transaction of that marketer.” The software assigns a unique affiliate identifier for each individual affiliate. A user-initiated transaction is received as a result of a referral from an affiliate. The user initiated transaction is associated with the affiliate identifier of the referring affiliate. A confirmation that the user-initiated transaction produced a “consumed transaction” (defined as a transaction in which the user payment has been received and the product or service delivery to that consumer is complete) associated with the affiliate identifier is collected. A commission associated with the consumed transaction referred by the affiliate is also received from the entity which delivered the product or service object of the transaction and/or derived the primary economic value of the transaction (heretofore described as the “Merchant”). The commission is deposited into a central fund managed by the marketing program administrator (“the Administrator” or “Administrator”) for use in all disbursements to satisfy the obligations of marketing agreements entered into the course of this program. A payment to the affiliate is based on the specific agreement upon terms of the particular affiliate relationship and is sometimes further based on the total value of the consumed transaction as established by the Administrator with the concordance of the Merchant. In a preferred embodiment, the memory element generates a payment signal in response to determining the payment for the affiliate. A microprocessor is operatively coupled to receive the payment signal from the memory element. The microprocessor transmits a payment to the affiliate in response to receiving the payment signal.

Related methods of operation and computer readable media are also provided. Other systems, methods, features, and advantages of the invention will be or become apparent to one skilled in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The invention can be better understood with reference to the following figures. The components within the figures ate not necessarily to scale, emphasis instead being placed upon clearly illustrating the principles of the invention. Moreover, in the figures, like reference numerals designate corresponding parts or blocks throughout the different views.

FIG. 1 is a block diagram of a self-funded commission management system.

FIG. 2 is a flow chart illustrating an algorithm that describes the operation of the commission management software of FIG. 1.

FIG. 3 is a flow chart of a first implementation of the algorithm described with reference to the flow chart of FIG. 2.

FIG. 4 is a flow chart for a second implementation of the algorithm described with reference to the flow chart of FIG. 2.

FIG. 5 is a table listing collections and disbursements for three sample companies that use the self-funded commission management system of FIG. 1.

While the invention is susceptible to various modifications and alternative forms, specific embodiments have been shown by way of example in the drawings and subsequently are described in detail. It should be understood, however, that the description herein of specific embodiments is not intended to limit the invention to the particular forms disclosed. In contrast, the intention is to cover all modifications, equivalents, and alternatives falling within the spirit and scope of the invention as defined by the appended claims.

### DETAILED DESCRIPTION OF THE DRAWINGS

As used in the specification and the appended claims, the singular forms “a,” “an” and “the” include plural referents unless the context clearly dictates otherwise. Similarly, “optional” or “optionally” means that the subsequently described event or circumstance may or may not occur, and that the description includes instances where the event or circumstance occurs and instances where it does not. For example, the phrase “optionally processes hotel transactions” means that the hotel transaction may or may not be processed and that the description includes both processing the hotel transaction and not processing the hotel transaction where there is substitution.

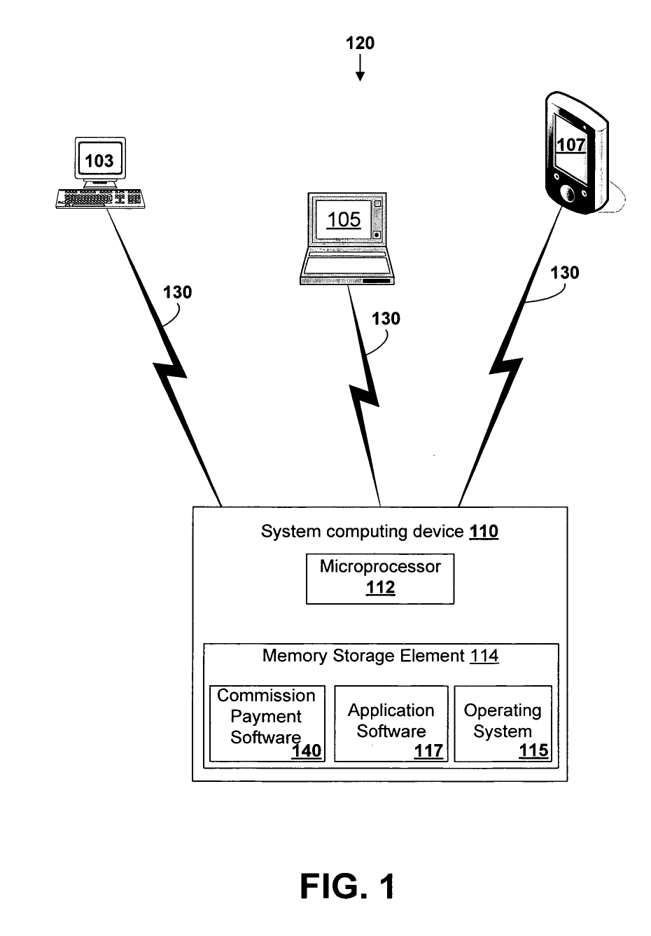

FIG. 1 is block diagram of an embodiment of the self-funded commission management system 100 that includes a system computing device 110. This computing device may include a microprocessor 112 and a memory element 114. The microprocessor 112 can be any special purpose or general purpose processor capable of executing the instructions within software stored on the memory element 114. The memory element 114 can include any one or a combination of volatile memory elements (e.g., random access memory (RAM), such as DRAM, SRAM, etc.) and non-volatile memory elements (e.g., RAM, ROM, hard-drive, tape, CDROM, etc.). Moreover, the memory element 114 may incorporate electronic, magnetic, optical, and/or other types of storage media. In addition, the memory element 114 can have a distributed architecture, where various components are situated remotely from one another, but are accessible by the microprocessor 112.

In addition, the system 100 may optionally include numerous user computing devices 120, such as a terminal 103, laptop 105, or personal digital assistant 107. Like the system computing device 110, the user computing devices 120 may also include a mictoprocessor (not shown) and a memory element (not shown). The system computing device 110 may connect to the user computing devices 120 using the communication media 130. This communication media can be a local area network, wide area network, wireless network, the Internet, or some other suitable media.

The software in memory element 114 may include one or more separate programs, each of which comprise one or more code segments, which are an ordered listing of executable instructions for implementing logical functions. In the example of FIG. 1, the software in the memory element 114 includes an operating system 115, application software 117, and commission management software 140. The application software 117 is executed by the microprocessor 112 in order to perform task specific operations of the system computing device 110. The commission management software 140 includes the software code segments that are executed by the microprocessor 112 or another device for providing self-funded commission managements. This software is described in more detail with reference to the subsequent flow charts.

As the commission management software 140 pays an invoice, the memory element 114 generates a payment signal that is received by the microprocessor 112. The microprocessor 112 can then transmit an invoice payment signal from the commission management system 100, which can trigger a payment to the affiliate based upon an agreed upon amount as set by the program Administrator

In addition, the commission management software 140 can be stored on a computer-readable medium. In the context of this document, a “computer-readable medium” can be any means that can contain, store, communicate, propagate, or transport the program for use by or in connection with the instruction execution system, apparatus, or device. The computer-readable medium can be, for example, but, not limited to, an electronic, magnetic, optical, electromagnetic, infrared, or semiconductor system, apparatus, device, or propagation medium. More specific examples (a non-exhaustive list) of the computer-readable medium can include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium can even become paper or another suitable medium upon which the program is printed. The program can be electronically captured, via, for instance, optical scanning of the paper or other medium, then compiled, interpreted or otherwise processed in a suitable manner if necessary, and then stored in a computer memory.

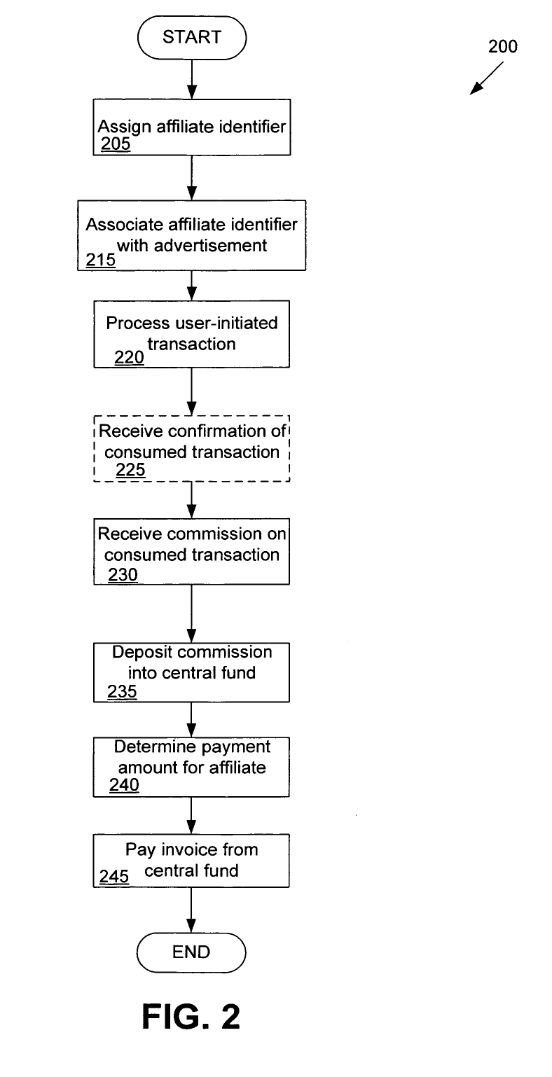

FIG. 2 is a flow chart 200 illustrating an algorithm that describes the operation of the commission management software 140 (see FIG. 1). Any process descriptions or blocks in the flow charts can be understood as representing modules, segments, or portions of code, which may include one or more executable instructions for implementing specific logical functions or blocks in the process. Alternative implementations are included within the scope of the invention in which functions may be executed out of order from that shown or discussed, including substantially concurrently or in reverse order, depending on the functionality involved, as can be understood by those reasonably skilled in the art.

In block 205, an affiliate identifier is assigned to affiliate. An affiliate can be any type of organization that provides services in either a direct exchange or indirect exchange for payment. For example, an affiliate may be a company that provides advertising services or one which delivers visitor traffic to the website of the company to which it is affiliated. As mentioned above, a single company may use a variety of advertising vehicles, which can result in numerous affiliates. As an alternative, all affiliates can be optionally assigned affiliate identifiers in this block to assist with tracking and management of the affiliate relationship. The affiliate identifier can be any kind of unique identifier possibly in a specific standardized format or syntax as used by a particular industry, such as an identifier for the travel industry patterned after the International Air Transport Association number (“IATA”) schema, also know as a (“pseudo-IATA”). Using a pseudo-IATA as an affiliate identifier for an implementation within the travel industry may enable a separate system, originally designed to track, manage, and process commissions for traditional travel agencies, to be additionally purposed for the management of the relationship with the affiliate. Similar standardized tracking systems for other industries may also exist and may be repurposed in similar ways.

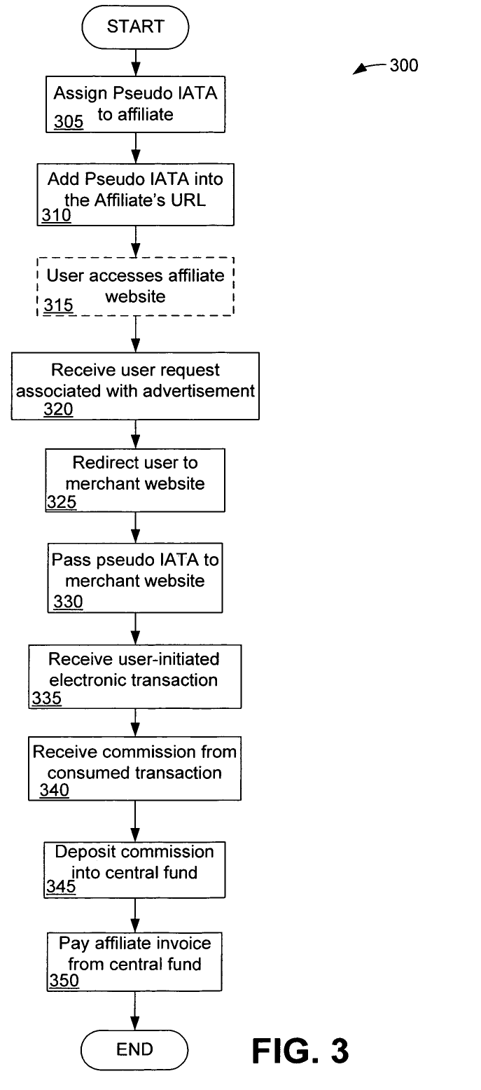

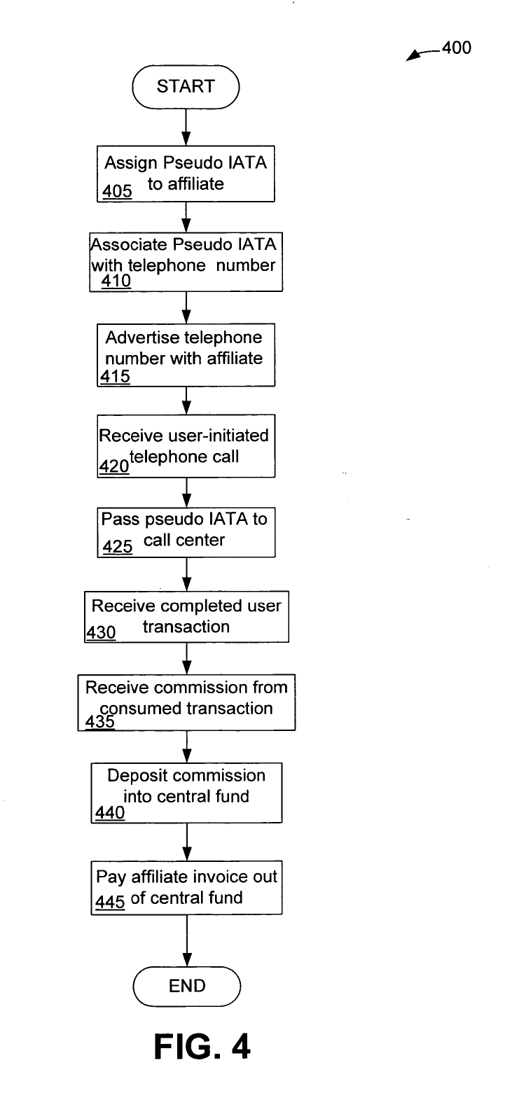

The affiliate identifier is associated with the advertisement in block 215. To make this association, the affiliate identifier can be integrated within reference information associated with the advertisement. When the advertisement occurs on the Internet, for example, the affiliate identifier can be attached to a uniform resource locator. This implementation is described in greater detail with reference to FIG. 3. Alternatively, the affiliate identifier can be associated with a telephone number, which is described in greater detail with reference to FIG. 4. While associating the affiliate identifier with a uniform resource locator and a telephone number is described, other embodiments can result from associating the affiliate identifier with other aspects of the advertisement.

In block 220, a user-initiated transaction is processed. Processing this transaction includes applying an appropriate tracking identifier that enables the transaction origin to be traced back to the referring affiliate. In block 220, processing the transaction can include receiving a user-initiated transaction. For example, User X with one of the user computing devices 120 may access the affiliate's website. After accessing the website, User X may initiate a transaction (the type of transaction used in this example), such as a hotel transaction, car rental transaction, or airline transaction. When this user-initiated transaction is processed, the affiliate identifier is associated with the transaction. In this example, the transaction may be stored in the memory element 114 with the affiliate identifier. User-initiated transactions do not need to be restricted to a company's website, but may be conducted by contacting a call center, contacting the hotel directly for voice or fax transactions, or otherwise pursuing a transaction.

The flow chart 200 may optionally include block 225 where confirmation of a completed user-initiated transaction (for example, a hotel transaction which as been “consumed” or otherwise completed and paid for) is received. In other words, the commission management system 100 receives notification, such as notice from a third-party, that the transaction initiated by the user actually resulted in a completed transaction. For example, Hotel A may transmit a notice to the commission management system 100 that User X completed and paid for his hotel stay based on the earlier transaction, initiated by the user that was referred by an affiliate. To transmit this notice, the communication media 130 can be used.

In block 230, a commission on the consumed transaction is received. The process of tracking, collecting and paying commission can be performed, in one embodiment, by a third-party. The commission is received through a system designed to track and manage all commissionable activity by a commissioned entity and is wire transferred to the central fund (see block 235). The commission may be any type of commission, such as a commission that is a percentage of the total cost spent by the user. For example, the commission can be ten percent of the total bill for User X. A commission may also be a flat payment amount for each transaction or some other payment term negotiated with a particular affiliate. This commission can be transmitted to the commission management system 100 along the communication media 130.

The received commission is deposited into a central fund at block 235. The central fund may be a data location within the memory 114. Alternatively, the central fund can be stored in a location external to the system computing device 110 that is accessible via the communication media 130. By depositing all commissions into the central fund, the self-funded commission management system 100 can share resources across numerous advertising campaigns.

In block 240, payment amounts are determined compensation factors associated with the affiliates. These compensation factors are based on the specific agreement between the particular affiliate and the Merchant is sometimes further based on the total value of the consumed transaction as established by the Administrator with the concordance of the Merchant. This total value may be measured by a function of comparing accumulated gross revenues for each affiliate against a specific revenue target, by a calculation of the net profit before payment to the affiliate, or by comparing the relative productivity versus other affiliates that it represents.

As mentioned above, the self-funded commission management system 100 can reallocate resources across multiple advertising campaigns. Consequently, the central fund enables resource reallocation based on performance variables. For example, the commission management system 100 can allocate additional funds to advertising campaign B, which is performing outside of the desired metrics, by taking surplus commission funds generated by advertising campaign C. In addition, this reallocation can take place each month, which makes the system dynamic. The performance variables are set by the individual Merchant or administrator and may be based on whatever value metrics are appropriate to the Merchant's business.

Invoices are paid from the central fund in block 245. When the flow chart 200 is accomplished by the commission management software 140, the memory storage element 114 can transmit the previously described payment signal. In response, microprocessor 112 within the system computing device 110 can transfer the invoice payment signal to the marketing program administrator or other automated system, which disburses a check as described above.

FIG. 3 is a flow chart 300 of a second embodiment of the algorithm described with reference to the flow chart 200. In block 305, a pseudo-IATA, or industry-specific tracking identifier, is assigned to the affiliate. In other words, this implementation uses a pseudo-IATA as the affiliate identifier previously described with reference to the chart 200. The pseudo-IATA can be assigned to the affiliate during an affiliate recruitment or registration process at the onset of the relationship 100. Each affiliate receives a unique pseudo-IATA. Because a pseudo-IATA is being used as the affiliate identifier and has a format and syntax matching that of the IATA number system, the commission management system 100 can utilize currently existing technology that is unique to the travel industry. In other words, in the travel industry most travel suppliers have some type of travel agent commission tracking, management, or reconciliation (payment) system designed to use the unique identifier assigned by the IATA organization to each agency. Pseudo-IATA numbers have a format or syntax which matches that of the real IATA numbers but are only used by individual suppliers and cannot be used across suppliers to identify a particular affiliate. These pseudo-IATA numbers can, however, be processed by the travel agent commission management system, thus, eliminating the need for the travel supplier to re-invent a new tracking and management solution for its affiliates.

The pseudo-IATA is added to the uniform resource locator (URL) used by the affiliate in creating links to the affiliate program operators website in block 310. A URL is unique address information that is accessible on the Internet. In a preferred embodiment, each affiliate has a website of its own containing contents of some sort, as well as, links to other sites, each of which is composed of associated URLs that is attainable by users with the user computing devices 120. As mentioned above, the pseudo-IATA can, through a virtually unnoticeable modification of the appropriate link's URL, be passed through to the transaction record of the travel supplier website to which the user is taken upon activating the corresponding link on the affiliate's website.

In block 315, a user is granted access to the affiliate program operator's website from the activated link on the affiliate's website. As mentioned above, a user may access the website with any one of the user computing devices 120. Block 315 is shown in dashed lines because it indicates actions by a user instead of a process completed by the self-funded commission management system 100.

A user request associated with the advertisement is received in block 320. In a preferred embodiment, the transaction is received through the communication media 130 (see FIG. 1). This request may be received when a user activates a link containing one or more tracking identifiers while visiting the affiliate's website. For example, a user may activate a link associated with a lodging merchant, for example, while visiting the affiliate's website. While described with respect to a lodging merchant, the novel component identification system 100 is equally applicable to various types of merchants, such as automobile merchants, or airline merchants.

In block 325, a user is redirected to a merchant's website, which can be done in response to receiving the user request. This redirection can result from a user activating a link on the affiliate's website that includes a tracking identifier. Using the example described with reference to block 320, a user is redirected to the lodging merchant's website after activating a link with a tracking identifier associated with the lodging merchant.

The pseudo-IATA is passed to the merchant's website in block 330. Because the pseudo-IATA is added to the affiliate's URL, passing the pseudo-IATA implicitly identifies the affiliate company that prompted a user to visit the merchant's website. In the example above, a user on Affiliate A's website may activate a link resulting in redirection to the merchant's website. For this example, the pseudo-IATA is passed to the lodging merchant's website in block 330, but the pseudo-IATA identifies Affiliate A's website.

In block 335, a user-initiated electronic transaction is received. While visiting a merchant's website, a user may initiate a transaction with the merchant. This transaction may be any kind of transaction, such as reserving a hotel room, airline ticket, car rental, or some other suitable transaction. Though described with the previously listed transactions, other types of transactions are also within the scope of the present invention. In this implementation, the electronic transaction is received through the communication media 130 (see FIG. 1).

A commission associated with a consumed transaction is received in block 340. Though not shown, the flow chart 300 may include a block before block 230 where confirmation of the consumed transaction is received (see block 225 in FIG. 2). As described with reference to block 230, a consumed transaction is a transaction that resulted in a sale. For example, the transaction received in block 335 can be for a hotel room. In this example, a consumed transaction is a transaction that results in the user reserving, staying in, and paying for the hotel room. The commission associated with the consumed transaction can be collected using the communication media 130.

In block 345, the collected commission is deposited in a central fund. Block 345 is functionally equivalent to block 235. Hence, that description is not repeated here.

In block 350, affiliate invoices are paid with the money from the central fund. Though not shown, the flow chart may also include a block where payment amounts for the affiliates are determined as described with reference to FIG. 2. Affiliates may issue a monthly invoice based on the amount of advertising they delivered. The payments received by the affiliates can be applied to their invoices. As mentioned above with reference to block 240, the commission management system 100 may reallocate resources within the central fund to cover the affiliate's invoice. An affiliate may be paid by check or by using an electronic transfer of funds along the communication media 130. The flow chart 300 ends after block 350.

FIG. 4 is a flow chart 400 of a second implementation of the algorithm described with reference to the flow chart 200. Block 405 is functionally equivalent to block 305 so the description is not repeated. In block 410, the pseudo-IATA is associated with a telephone number. In other words, the tracking identifier described with reference to block 210 (see FIG. 2) is a telephone number in this implementation. The telephone number may be a seven digit number, ten digit number, or some other suitable number.

In block 415, a telephone number is advertised with the affiliate. This telephone number is associated with a merchant and is unique to the affiliate

A telephone call is received from a user in block 420. For example, a user may contact a call center by dialing from a remote location using a standard telephone (not shown). Alternatively, a user may contact a call center using the portable digital assistant 107 (see FIG. 1). In block 420, a transaction is received from the user. In one implementation, a customer service representative in the call center may receive the transaction. This representative may transmit the transaction to the commission management system 100 using the terminal 103. In an alternative implementation, block 415 and block 420 can be combined.

A pseudo-IATA is passed to the call center in block 425 via a display on the customer service representatives' telephones. Alternatively, the pseudo-IATA can be passed through the Vector Directory Number “VDN”.

A completed user transaction is received in block 430. In flow chart 400, the remaining blocks 435-445 are functionally equivalent to blocks 335-340 and the description is not repeated.

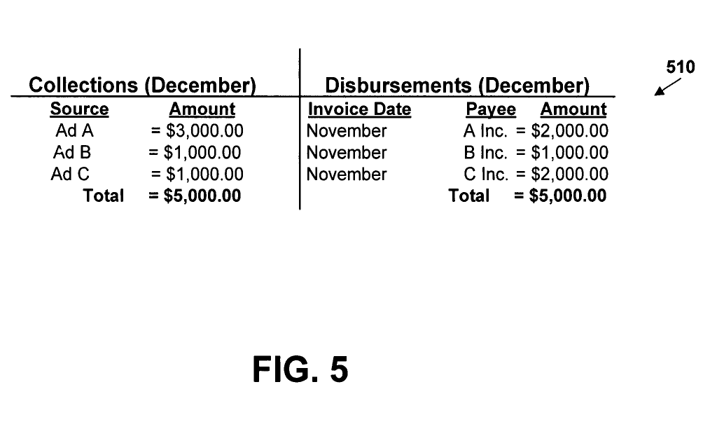

As mentioned above, the commission management system 100 facilitates redistribution of resources among various companies, which is more clearly seen with reference to FIG. 5. FIG. 5 is a table 510 that lists the collections and disbursements for a sample company that uses the self-funded commission management system 100. The table 510 illustrates reallocation of resources for one sample company using the commission management system 100 across three sample affiliates. In December, the company using the self-funded commission management system 100 receives commissions in the amount of $3,000, $1,000, and $1,000 associated with consumed transactions based on advertising with affiliates A, B, and C. These commissions are collected from the primary beneficiary of the advertisement. This respectively produces a total central fund deposit of $5,000. During the same month, the company pays invoices in the amounts of $2,000, $1,000, and $2,000 to affiliate companies A, B, and C respectively. Because the collection associated with Ad A is $3,000 and the invoice total is only $2,000, the amount in the central fund increased by $1,000. This surplus is used by the system to fund the cash deficit generated by the difference between the $1,000 collected for affiliate C's advertising performance and the disbursement amount of $2,000 paid to affiliate C for November's invoice. This method of re-allocating and balancing resources enables the advertiser or administrator to mitigate the performance variations of different affiliate relationships over time.

The self-funded commission management system 100 creates several advantages. The current system is self-funded, which eliminates time and resources previously used in getting an approved budget. In addition, a company's advertising budget can now be determined by the successfulness of the advertising campaigns. Campaigns with a greater return on investment can now have more funds allocated, which create more flexibility on how resources are spent. Thus, the commission management system is quite dynamic, which allows purchasing advertising previously deemed unattainable due to the difficulty in forecasting the performance of advertisements over time or the variations in cost/benefit ratios across multiple affiliates at different points in time which, treated individually, would otherwise make many individual relationships financially untenable at any particular point in time based upon an excessively high cost of sale.

While various embodiments of the invention have been described, it may be apparent to those of ordinary skill in the art that many more embodiments and implementations are possible that are within the scope of this invention. For example, while illustrated with advertising commissions, the invention is applicable to any type of commissions. All such modifications are intended to be included within the scope of this disclosure and the present invention and protected by the following claims.

1. A method for generating self-funded commission management for an affiliate, the steps of the method comprising:
assigning an affiliate identifier for an affiliate;
receiving a user-initiated transaction in response to a referral from the affiliate;
associating the user-initiated transaction with the affiliate identifier;
receiving a confirmation that the user-initiated transaction produced a consumed transaction associated with the affiliate identifier;
receiving a commission associated with the consumed transaction when the user-initiated produced the consumed transaction;
depositing the commission in a central fund; and
determining a payment for the affiliate based on compensation terms associated-with the affiliate.

2. The method of claim 1, wherein assigning an affiliate identifier includes assigning an industry-specific, tracking identifier for the affiliate.

3. The method of claim 2, further comprising the step of associating the industry-specific, tracking identifier with a uniform resource locator for a website of the affiliate having an advertisement.

4. The method of claim 3, further comprising the step of granting a user access to the website of the affiliate.

5. The method of claim 4, further comprising the step of receiving a user request associated with the advertisement, wherein the user request produces the user-initiated transaction.

6. The method of claim 2, further comprising the step of associating the industry-specific, tracking identifier with a telephone number.

7. The method of claim 6, further comprising the step of transmitting the industry-specific, tracking identifier to a call center.

8. The method of claim 7, wherein the step of transmitting produces the user-initiated transaction.

9. The method of claim 1, further comprising the step of transferring the payment to the affiliate.

10. A self-funded commission management system comprising:
a memory storage element for storing commission management software, wherein the commission management software comprises the steps of:
assigning an affiliate identifier for an affiliate;
receiving a user-initiated transaction in response to a referral from the affiliate;
associating the user-initiated transaction with the affiliate identifier;
receiving a confirmation that the user-initiated transaction produced a consumed transaction associated with the affiliate identifier;
receiving a commission associated with the consumed transaction when the user-initiated produced the consumed transaction;
depositing the commission in a central fund; and
determining a payment for the affiliate based on compensation terms associated with the affiliate.
a microprocessor operatively coupled to receive the payment signal from the memory element, wherein the microprocessor transmits a payment to the affiliate in response to receiving the payment signal.

11. The system of claim 10, wherein the step of assigning an affiliate identifier includes assigning an industry-specific, tracking identifier for the affiliate.

12. The system of claim 11, wherein the software further comprises the step of associating the industry-specific, tracking identifier with a uniform resource locator for a website of the affiliate having an advertisement.

13. The system of claim 10, wherein the software further comprises the step of associating the industry-specific, tracking identifier with a telephone number.

14. A computer readable medium for self-funded commission managements having instructions comprising the steps of:
assigning an affiliate identifier for an affiliate;
receiving a user-initiated transaction in response to a referral from the affiliate;
associating the user-initiated transaction with the affiliate identifier;
receiving a confirmation that the user-initiated transaction produced a consumed transaction associated with the affiliate identifier;
receiving a commission associated with the consumed transaction when the user-initiated produced the consumed transaction;
depositing the commission in a central fund; and
determining a payment for the affiliate based on compensation terms associated with the affiliate.

15. The computer readable medium claim 14, wherein assigning an affiliate identifier includes assigning an industry-specific, tracking identifier for the affiliate.

16. The computer readable medium of claim 15, further comprising the step of associating the industry-specific, tracking identifier with a uniform resource locator for a website of the affiliate having an advertisement.

17. The computer readable medium of claim 16, further comprising the step of granting a user access to the website of the affiliate.

18. The computer readable medium of claim 16, further comprising the step of receiving a user request associated with the advertisement, wherein the user request produces the user-initiated transaction.

19. The computer readable medium of claim 15, further comprising the step of associating the industry-specific, tracking identifier with a telephone number.

20. The computer readable medium of claim 16, further comprising the step of transferring the payment to the affiliate.
